(19) United States
(12) Patent Application Publication
(10) Pub. No.: US 2025/0307311 A1
(43) Pub. Date: Oct. 2, 2025

(54) SYSTEM AND METHOD FOR CREATING RECOMMENDATION RESTORATION POINTS IN A MEDIA ACCOUNT

(71) Applicant: TiVo Platform Technologies LLC, San Jose, CA (US)

(72) Inventors: Govind RAVEENDRANATHAN NAIR, Bangalore (IN); Sangeeta PARIDA, Bangalore (IN); Vasanth Raj RAJANNA, Bangalore (IN)

(21) Appl. No.: 19/090,863

(22) Filed: Mar. 26, 2025

Related U.S. Application Data
(60) Provisional application No. 63/570,020, filed on Mar. 26, 2024.

(51) Int. Cl. G06F 16/735

(52) U.S. Cl. CPC G06F 16/735

(57) ABSTRACT

A system and method for creating recommendation restoration points for the media recommendation profile are disclosed. The system receives content consumption data pertaining to media contents played on media devices associated with a media account, analyzes the received content consumption data to identify parameters associated with the media contents played during certain duration, and identifies a deviation of content consumption behavior with respect to historical content consumption behavior associated with the media recommendation profile or sub-profiles related to the media account based on analysis of the parameters. The system allows an authorized user of media account to mark content consumption data collected after or between different restoration points to be discarded from media recommendation profile to prevent content recommendation based on content consumption data collected after or between different restoration points.

### CROSS-REFERENCE TO RELATED APPLICATIONS

The present application claims the benefit of the filing date of U.S. Provisional Patent Application No. 63/570,020, filed on Mar. 26, 2024, the disclosure of which is hereby incorporated by reference.

### BACKGROUND

### Technical Field

The present disclosure relates to the field of media recommendations, and particularly relates to a system and method for creating recommendation restoration points in a media account.

### Description of Related Art

In the evolving landscape of digital content consumption, personalized recommendation engines have become integral to enhancing user satisfaction and engagement. Such recommendation engines continuously analyze user behavior, preferences, and viewing patterns to generate tailored content suggestions. Typically, the existing recommendation engines primarily rely on the real-time analysis of a user's viewing history to generate personalized content recommendations. This poses a problem when a user account is utilized by multiple individuals, especially in scenarios where a shared television is accessed by family members and guests temporarily. When a media account is used by one or more users, as they regularly reside in the same house or are part of the same family, the recommendation systems are designed to maintain multiple sub-profiles and provide content recommendations tailored for the one or the sub-profiles that is presently consuming the content. Even though these sub-profiles are not selected manually, the existing systems can be determined for which sub-profile it need to provide recommendations during a content consumption session. The issue occurs when a guest uses the same media account for a certain period. In such cases, the media recommendation profile or any of the sub-profile associated with the media account gets updated based on the content consumption of the guest, which may lead to a diluted and less relevant set of content recommendations in the future. The lack of an effective mechanism to differentiate and manage the user's viewing pattern within the media account results in a compromised and less accurate content recommendation experience. For example, consider a user hosting guests who share a common television for entertainment purposes. Thus, the guest's distinct viewing preferences during their temporary use of the shared account are incorporated into the media recommendation profile of the media account. Consequently, the personalized recommendation list becomes a combination of the primary users' established preferences and the transient preferences of the guest user, resulting in suboptimal and potentially unwanted content suggestions.

Additionally, or alternatively, similar issues are observed in instances when the user makes exception(s) in viewing patterns for various reasons, such as emotional discomfort, a special occasion, a special match, or the like. In such instances, the existing technology includes the exception(s) in the viewing patterns for providing recommendations to the user. Thus, the existing technology lacks an efficient mechanism to address such issues and show the user's personalized content recommendations effectively.

Therefore, there is a need for a dynamic personalized content recommendation system that not only adapts to the user's viewing pattern but also intelligently manages media accounts to avoid contamination of recommendations by temporary users and/or exceptions in the viewing patterns.

### BRIEF SUMMARY

One or more embodiments are directed to a system and method for creating recommendation restoration points in a media account. Such recommendation restoration points serve as snapshots of a user's content preferences at specific points in time, allowing a user associated with the media account to revert to an earlier instance of a media recommendation profile. An embodiment of the present disclosure discloses a system for creating recommendation restoration points for the media recommendation profile. The system includes a receiver module to receive content consumption data pertaining to media contents played on one or more media devices associated with the media account, an analyzer module to analyze the received content consumption data to identify one or more parameters associated with the media contents played during certain duration, and an anomaly detector to identify a deviation of temporary content consumption behavior with respect to historical content consumption behavior associated with the media recommendation profile or one or more sub-profiles related to the media account based on analysis of the one or more parameters.

In some embodiments, the media account corresponds to a unique profile, associated with a user or a user device, maintained by an Over The Top (OTT) provider, a linear content provider, a media aggregator, or a content recommendation system. The one or more sub-profiles correspond to the viewing pattern of one or more primary users of the media account.

In some embodiments, the one or more parameters include genre of content, time of content consumption, length of content consumption, rating associated with the media content, associated actors, associated directors, associated scriptwriter, language of media content, plot information associated with media content and other such metadata that can be used by any recommendation engine. In an embodiment, the temporary content consumption behavior associated with the media account is continuously analyzed with respect to its historical content consumption behavior to determine derivation and hence anomaly in content consumption behavior of the media account.

A multi-dimensional vector representing the media recommendation profile of the media account is used to maintain historical content consumption behavior. Data points from content consumption data are compared with respect to this multi-dimensional vector to determine deviation. The deviation corresponds to deviation from the viewing patterns of the user corresponding to the media recommendation profile or the one or more sub-profiles in terms of genre of content, time of content consumption, length of content consumption, rating associated with the media content, associated actors, associated directors, associated scriptwriter, language of media content, plot information associated with media content and other such metadata that can be used by any recommendation engine.

In one scenario, the anomaly detector detects an anomaly in content consumption behavior, if the identified deviation is more than a pre-defined threshold. The pre-defined threshold is determined based on calculated standard deviation of the media recommendation profile or any of the sub-profiles, or can be calibrated manually by the one or more users associated with the media account.

In another scenario, if the identified deviation is less than the pre-defined threshold, then the system considers this deviation as one of the one or more sub-profiles. In yet another scenario, if the anomaly occurs regularly for more than a pre-defined number of times, then the anomaly is considered a new sub-profile and stored in the database. In yet another scenario, if the similar anomalies occur more than a pre-defined number of times, the system can highlight such similar anomalies and after confirmation from any of the primary users consider such anomalies to update sub-profiles or build a new sub-profile.

In an embodiment, the system includes a restoration point creator to create a restoration point based on the detection of the anomaly to mark content consumption data collected after or between different restoration points to be discarded from the media recommendation profile. The system may further facilitate the user to select the restoration point. The restoration point may be presented over a timeline graph along with time reference to the user Further, the restoration points are presented along with an associated tag, indicative of a past time to facilitate the primary users to restore the instant of the media recommendation profile or sub-profiles that the recommendation engine should use to provide a content recommendation. The system allows the user of the media account to mark content consumption data collected after or between different restoration points to be discarded from the media recommendation profile, so as to prevent content recommendation based on content consumption data collected after or between different restoration points Accordingly, based on the selection of the restoration point, the system can help restore instance of the media recommendation profile before the detected anomaly in the content consumption behavior of the media account by removing the content consumption data collection after the restoration point to improve accuracy of personalized recommendation.

In an embodiment, the system further includes a sub-profile creator to form the one or more sub-profiles based on the identified one or more parameters associated with the media contents played on the one or more media devices.

An embodiment of the present disclosure discloses the method for creating recommendation restoration points in the media account. The method includes the steps of receiving content consumption data pertaining to media contents played on one or more media devices associated with the media account and fetching a media recommendation profile and one or more sub-profiles associated with the media account.

Further, the method includes the steps of analyzing the received content consumption data to identify one or more parameters associated with the media contents played on the one or more media devices. Furthermore, the method includes the steps of identifying a deviation of content consumption behavior with respect to historical content consumption behaviors of the one or more sub-profiles based at least on the identified one or more parameters. In an embodiment, the method includes the steps of forming the one or more sub-profiles based on the identified one or more parameters associated with the media contents played on the one or more media devices. The method also includes the steps of detecting anomalies in the content consumption behavior if the identified deviation is more than a pre-defined threshold. The pre-defined threshold is determined based on calculated standard deviation of the media recommendation profile or any of the sub-profiles, or can be calibrated manually by the one or more users associated with the media account.

In another scenario, if the identified deviation is less than the pre-defined threshold, then the identified deviation is considered as one of the one or more sub-profiles. In yet another scenario, if the anomaly occurs regularly for more than a pre-defined number of times, then the anomaly is considered a new sub-profile and stored in the database. In yet another scenario, if the similar anomalies occur more than a predefined number of times, such similar anomalies are highlighted to the user, and after confirmation from any of the primary users such anomalies are considered to update sub-profiles or build a new sub-profile.

In an embodiment, the method includes the steps of creating a restoration point based on the detection of the anomaly to facilitate a user to select the restoration point. The created restoration point is presented over a timeline graph along with a time reference to the user. Thereafter, the method includes the steps of updating the media recommendation profile by removing the content consumption data collected after the restoration point to improve the accuracy of personalized recommendations.

The disclosed system and method (together termed as ‘disclosed mechanism’) provide enhanced control to the user over content recommendations, especially in scenarios involving shared media accounts. The disclosed mechanism introduces recommendation restoration points by leveraging anomaly detection to revert to previous recommendation patterns before a particular date, situation, or event, promoting a more personalized and satisfactory viewing experience for the user. Accordingly, the disclosed mechanism strikes a balance between adaptability to evolving user preferences and the preservation of desired content recommendations, thus improving overall user satisfaction within the recommendation systems in shared user account environments.

The features and advantages of the subject matter here will become more apparent in light of the following detailed description of selected embodiments, as illustrated in the accompanying FIGURES. As will be realized, the subject matter disclosed is capable of modifications in various respects, all without departing from the scope of the subject matter. Accordingly, the drawings and the description are to be regarded as illustrative in nature.

### BRIEF DESCRIPTION OF THE DRAWINGS

In the figures, similar components and/or features may have the same reference label. Further, various components of the same type may be distinguished by following the reference label with a second label that distinguishes among the similar components. If only the first reference label is used in the specification, the description is applicable to any one of the similar components having the same first reference label irrespective of the second reference label.

FIG. 1 illustrates an exemplary environment having a media device connected to a network for receiving one or more content recommendations, in accordance with an embodiment of the present disclosure.

FIG. 2 illustrates an exemplary recommendation screen of the media device, in accordance with an embodiment of the present disclosure.

FIG. 3 illustrates a block diagram of a system for creating recommendation restoration points in a media account, in accordance with an embodiment of the present disclosure.

FIG. 4A illustrates an example implementation of the proposed system, by a media service provider that uses a third-party recommendation engine, in accordance with an embodiment of the present disclosure.

FIG. 4B illustrates another exemplary implementation of the proposed system, with a media service provider that has an inbuilt recommendation engine, in accordance with an embodiment of the present disclosure.

FIG. 4C illustrates another exemplary implementation of the proposed system, on a media device having its own recommendation engine, in accordance with an embodiment of the present disclosure.

FIG. 5A illustrates an exemplary illustration of anomaly clusters in comparison to a standard content consumption behavior of the media account, in accordance with an embodiment of the present disclosure.

FIG. 5B illustrates another exemplary illustration of the anomaly clusters in comparison to the content consumption behavior of the media account, in accordance with an embodiment of the present disclosure.

FIG. 5C illustrates yet another exemplary illustration of the anomaly clusters in comparison to the content consumption behavior of the media account, in accordance with an embodiment of the present disclosure.

FIG. 6A illustrates an exemplary media recommendation profile setting page with options of various restoration points created for different time ranges, in accordance with an embodiment of the present disclosure.

FIG. 6B illustrates an exemplary media recommendation profile setting page showing a highlighted restoration point of potential selection, in accordance with an embodiment of the present disclosure.

FIG. 6C illustrates a media recommendation profile setting page showing a highlighted restoration point on a mobile screen, in accordance with an embodiment of the present disclosure.

FIG. 7A illustrates an exemplary recommendation screen showing content recommendations based on restored media recommendation profile, in accordance with an embodiment of the present disclosure.

FIG. 7B illustrates an exemplary recommendation screen showing recommendations from various streaming platforms based on the restored media recommendation profile, in accordance with an embodiment of the present disclosure.

FIG. 7C illustrates an exemplary recommendation screen showing recommendations from a music streaming platform based on a restored media recommendation profile, in accordance with an embodiment of the present disclosure.

FIG. 8 is a flowchart of an operation for creating media recommendation profile restoration points in the media account, in accordance with an embodiment of the present disclosure.

FIG. 9 is a flowchart of an operation of user interaction with the presented restoration points, in accordance with an embodiment of the present disclosure.

FIG. 10 is a flow chart of a method for creating recommendation restoration points in the media account, in accordance with an embodiment of the present disclosure.

FIG. 11 illustrates an exemplary computer unit in which or with which embodiments of the present disclosure may be utilized.

Other features of embodiments of the present disclosure will be apparent from accompanying drawings and detailed description that follows.

### DETAILED DESCRIPTION

Embodiments of the present disclosure include various steps, which will be described below. The steps may be performed by hardware components or may be embodied in machine-executable instructions, which may be used to cause a general-purpose or special-purpose processor programmed with the instructions to perform the steps. Alternatively, steps may be performed by a combination of hardware, software, firmware, and/or by human operators.

Embodiments of the present disclosure may be provided as a computer program product, which may include a machine-readable storage medium tangibly embodying thereon instructions, which may be used to program the computer (or other electronic devices) to perform a process. The machine-readable medium may include, but is not limited to, fixed (hard) drives, magnetic tape, optical disks, compact disc read-only memories (CD-ROMs), and magneto-optical disks, semiconductor memories, such as ROMs, PROMs, random access memories (RAMs), programmable read-only memories (PROMs), erasable PROMs (EPROMs), electrically erasable PROMs (EEPROMs), flash memory, magnetic or optical cards, or other types of media/machine-readable medium suitable for storing electronic instructions (e.g., computer programming code, such as software or firmware).

Various methods described herein may be practiced by combining one or more machine-readable storage media containing the code according to the present disclosure with appropriate standard computer hardware to execute the code contained therein. An apparatus for practicing various embodiments of the present disclosure may involve one or more computers (or one or more processors within the single computer) and storage systems containing or having network access to a computer program(s) coded in accordance with various methods described herein, and the method steps of the disclosure could be accomplished by modules, routines, subroutines, or subparts of a computer program product.

### Terminology

Brief definitions of terms used throughout this application are given below.

The terms “connected” or “coupled”, and related terms are used in an operational sense and are not necessarily limited to a direct connection or coupling. Thus, for example, two devices may be coupled directly, or via one or more intermediary media or devices. As another example, devices may be coupled in such a way that information can be passed there between, while not sharing any physical connection with one another. Based on the disclosure provided herein, one of ordinary skill in the art will appreciate a variety of ways in which connection or coupling exists in accordance with the aforementioned definition.

If the specification states a component or feature “may”, “can”, “could”, or “might” be included or have a characteristic, that particular component or feature is not required to be included or have the characteristic.

As used in the description herein and throughout the claims that follow, the meaning of “a,” “an,” and “the” includes plural reference unless the context dictates otherwise. Also, as used in the description herein, the meaning of “in” includes “in” and “on” unless the context dictates otherwise.

The phrases “in an embodiment,” “according to one embodiment,” and the like generally mean the particular feature, structure, or characteristic following the phrase is included in at least one embodiment of the present disclosure and may be included in more than one embodiment of the present disclosure. Importantly, such phrases do not necessarily refer to the same embodiment.

Exemplary embodiments will now be described more fully hereinafter with reference to the accompanying drawings, in which exemplary embodiments are shown. This disclosure may, however, be embodied in many different forms and should not be construed as limited to the embodiments set forth herein. These embodiments are provided so that this disclosure will be thorough and complete and will fully convey the scope of the disclosure to those of ordinary skill in the art. Moreover, all statements herein reciting embodiments of the disclosure, as well as specific examples thereof, are intended to encompass both structural and functional equivalents thereof. Additionally, it is intended that such equivalents include both currently known equivalents as well as equivalents developed in the future (i.e., any elements developed that perform the same function, regardless of structure).

Thus, for example, it will be appreciated by those of ordinary skill in the art that the diagrams, schematics, illustrations, and the like represent conceptual views or processes illustrating systems and methods embodying this disclosure. The functions of the various elements shown in the figures may be provided through the use of dedicated hardware as well as hardware capable of executing associated software. Similarly, any switches shown in the figures are conceptual only. Their function may be carried out through the operation of program logic, through dedicated logic, through the interaction of program control and dedicated logic, or even manually, the particular technique being selectable by the entity implementing this disclosure. Those of ordinary skill in the art further understand that the exemplary hardware, software, processes, methods, and/or operating systems described herein are for illustrative purposes and, thus, are not intended to be limited to any particular named.

Embodiments of the present disclosure relate to a system and method for creating recommendation restoration points in a media account. Such recommendation restoration points serve as snapshots of a user's content preferences at specific points in time, allowing a user associated with the media account to revert to an earlier instance of a media recommendation profile.

In order to create such media recommendation profile restoration points, the proposed system employs anomaly detection techniques, which use metadata (e.g. genre, cast information, plot information, etc.) clustering and time-of-day analysis, to identify changes in viewing behavior of the media account. Such changes may be due to the use of the media device or the media account by any person other than primary users or by the primary users in exceptional scenarios of playing a media differing from the normal viewing pattern of the primary users. The normal media viewing patterns of the media account may be categorized into one or more sub-profiles representing clusters of metadata associated with the contents being watched and/or corresponding time associated with specific viewing patterns of one or more users associated with the media account. When such anomalies exceed a predefined threshold, a restoration point is created. The system can present these restoration points to the user and let the user select a restoration point. When the user selects a restoration point, the system sends an instruction to a recommendation engine to discard the user's viewing history after the restoration points and provide content recommendations as if nothing was watched after the time associated with the selected recommendation point. The system can also present a clustered set of metadata representing viewing anomalies to the primary users and let the primary users mark their preference of whether these clustered sets of metadata should affect its recommendation or not. When the primary user indicates that a certain clustered set of metadata should not affect its recommendation, the systems send an instruction to the recommendation engine to not consider these clustered sets of metadata to provide a content recommendation. The system facilitates the user to remove such anomalies from its media recommendations profile.

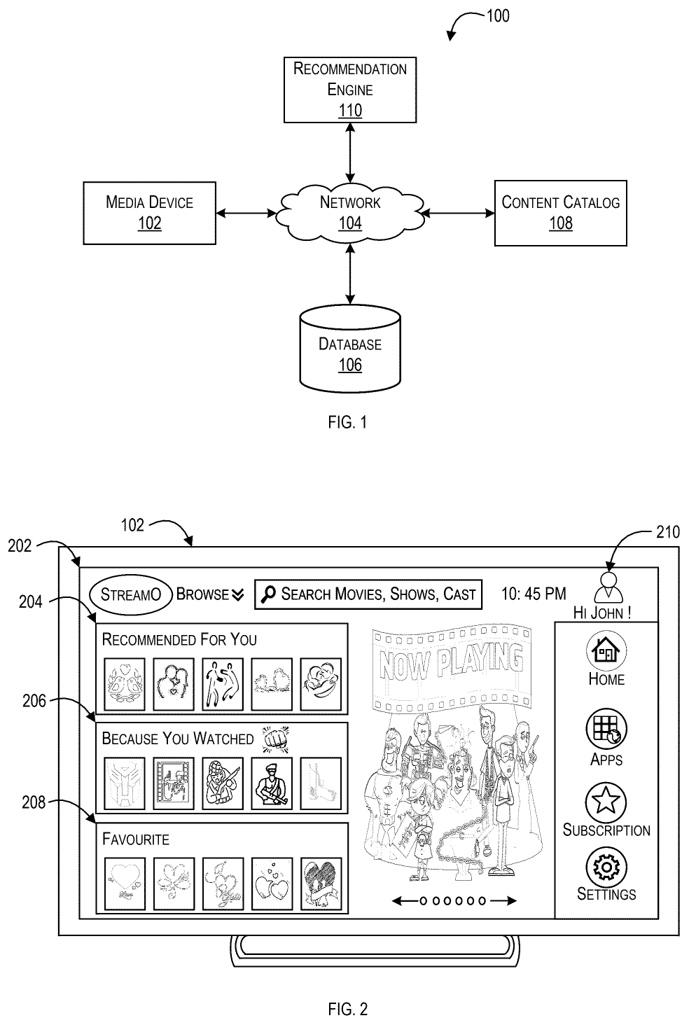

FIG. 1 illustrates an exemplary environment 100 having a media device 102 connected to a network 104 for receiving one or more content recommendations, in accordance with an embodiment of the present disclosure. FIG. 2 illustrates an exemplary recommendation screen 200 of the media device 102, in accordance with an embodiment of the present disclosure. For the sake of brevity, FIGS. 1 and 2 have been explained together.

In an embodiment, the exemplary environment 100 may include the media device 102, the network 104, a database 106, a content catalog 108, and a recommendation engine 110. The media device 102 may be connected to the network 104 to receive a list of recommended contents from the recommendation engine 110 and present the recommended contents for selection by a user. Once the user selects any of the recommended content, the selected content can be played. For preparing a list of recommended content from the available content catalog 108, the recommendation engine 110 uses a media recommendation profile associated with the media account linked to the media device 102. The media device 102 may be, without any limitation, a television, a streaming device, a mobile phone, a tablet, a computer, or any other multimedia player that may facilitate the user to play media content. Further, the network 104 (such as a communication network) may, without any limitation, include a direct interconnection, a Local Area Network (LAN), a Wide Area Network (WAN), a wireless network (e.g., using Wireless Application Protocol), the Internet, or another connectivity infrastructure. It may be apparent to a person skilled in the art that the media content may correspond to any audio content or video content, such as songs, movies, TV shows, sports, or the like. Accordingly, the content catalog 108 may include a diverse array of media, such as movies, TV shows, music, or any other type of content available for consumption to the user of the media account being accessed on the media device 102. It may be noted that each item in the content catalog 108 is associated with parameters, including genre, release date, director details, actors details, plot information, content rating, and other relevant metadata. In an embodiment, the database 106 may store the user's viewing history and/or user preference in terms of the number of times a certain categories of media content is watched, liked, or browsed. Accordingly, the database 106 may accumulate content consumption data on the user's past interactions with media contents, such as the types of shows, movies, or music the user has accessed, the genres preferred, and any other relevant user behavior to build the media recommendation profile.

In an embodiment, the recommendation engine 110 may analyze the user's viewing history stored in the database 106 to understand the user's preferences, interests, and patterns of media consumption. The recommendation engine 110 may employ various techniques, such as collaborative filtering, content-based filtering, or machine learning models, to identify similarities between the user's history and the media available in the content catalog 108. The recommendation engine 110 may consider factors like user ratings, duration of viewing, and time of day preferences for identifying such similarities. Based on the identified similarities, the recommendation engine 110 may generate a personalized list of recommended contents for the user and may cause such a list to be presented on a recommendation screen 202 of the media device 102, as shown in FIG. 2. As illustrated, the recommendations may, without any limitation, include different categories of recommended content. These recommended contents can be presented to the user as a ‘recommended for you’ option 204 including media that the user has not yet explored but is likely to enjoy based on past behavior (such as time of show, actor, genre, or the like), a ‘because you watched’ option 206 including media similar to watched media (such as action movie or violent movies), and a ‘favorite’ option 208 including media liked by the user or watched by the user more than a pre-defined number of times. The recommendation screen 202 may also display the media account ID 210 associated with the media account that has been logged into the media device 102. It may be apparent to a person skilled in the art that the user may interact with the recommended content through the media device 102 to watch, listen, or engage with the suggested content. Additionally, the media recommendation profile of the user stored in the database 106 may continuously get updated based on their interactions for refining the recommendations by the recommendation engine 110 over time. Accordingly, the exemplary environment 100 may create a dynamic feedback loop where the user's historical data stored in the database 106 may be continuously analyzed by the recommendation engine 110 to provide tailored suggestions from the content catalog 108. Thus, the user's experience may be enhanced by offering personalized and relevant recommendations based on continuously updated preferences.

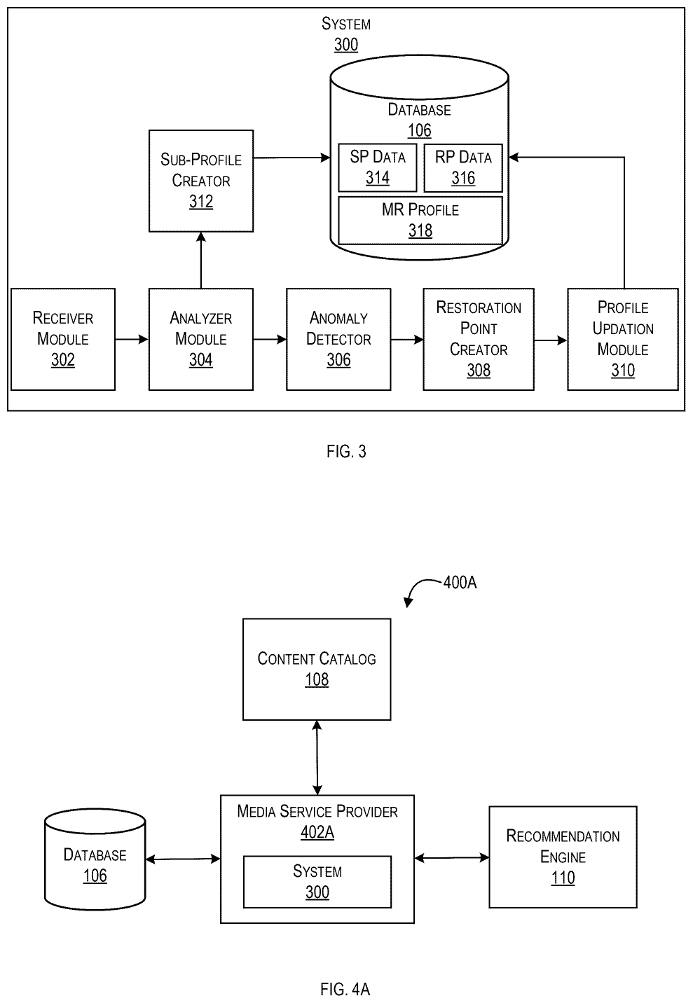

FIG. 3 illustrates a block diagram of a system 300 for creating recommendation restoration points in the media account, in accordance with an embodiment of the present disclosure.

In an embodiment, the system 300 may include a receiver module 302, an analyzer module 304, an anomaly detector 306, a restoration point creator 308, a profile updation module 310, a sub-profile creator 312, and the database 106. The receiver module 302, the analyzer module 304, the anomaly detector 306, the restoration point creator 308, the profile updation module 310, the sub-profile creator 312, and the database 106 may be communicatively coupled to a memory and a processor of the system 300. The processor may be configured to control the operations of the receiver module 302, the analyzer module 304, the anomaly detector 306, the restoration point creator 308, the profile updation module 310, the sub-profile creator 312, and the database 106. In an embodiment of the present disclosure, the processor and the memory may form a part of a chipset installed in the system 300. In another embodiment of the present disclosure, the memory may be implemented as a static memory or a dynamic memory. In an example, the memory may be internal to the system 300, such as an onside-based storage. In another example, the memory may be external to the system 300, such as cloud-based storage. Further, the processor may be implemented as one or more microprocessors microcomputers, microcomputers, digital signal processors, central processing units, state machines, logic circuitries, and/or any devices that manipulate signals based on operational instructions.

In an embodiment, the receiver module 302 may receive content consumption data pertaining to media contents played by the media device 102 associated with the media account. Alternatively, the content consumption data associated with the media account may be received from one or more media devices. The media account may correspond to a unique profile, associated with a user or a user device, maintained by an Over The Top (OTT) provider, a linear content provider, a media aggregator, or a content recommendation system. Further, the media account may be associated with an audio streaming platform and/or video streaming platform. In one scenario, only one device may be associated with the media account. In another scenario, one or more devices may be associated with the media account. The media account may be maintained by a media content provider, such as an Over-The-Top (OTT) content provider (e.g. Netflix, Amazon Prime, YouTube, etc), a linear content provider (e.g. a network operator like Sky), a media aggregator platform (e.g., TiVo aggregator App), a third-party recommendation engine, or a TV operating systems provider. In an embodiment, the receiver module 302 may fetch a media recommendation profile 318 and one or more sub-profiles associated with the media account. The media recommendation profile 318 may be a profile based on which the recommendation engine 110 may provide one or more recommendations to the user. Further, each of the one or more sub-profiles may correspond to a viewing pattern of a user associated with the media account. It may be apparent to a person skilled in the art that such viewing pattern may be associated with one or more associated media devices and/or one or more users associated with the media account. The creation of one or more sub-profiles is explained in detail in the following paragraphs.

In an embodiment, the analyzer module 304 may analyze the received content consumption data to identify one or more parameters associated with the media contents being played on the one or more media devices 102. The one or more parameters may, without any limitation, include genre of content (such as action, romantic, or the like), time of content consumption (such as played at night, played on the weekend, or the like), length of content consumption (such as less than 1 hour, or multiple seasons, or the like), rating associated with media content (such as adult rated, universal rated, or the like), associated actors (such as a particular actor, actress, or the like), associated director, associated scriptwriter, language of media content (such as Spanish, Korean, English, or the like), plot information associated with media content, and other such metadata that can be used by the recommendation engine 110. In one scenario, such identification of the one or more parameters may be based on the metadata associated with the media content stored in the content catalog 108. In other scenarios, the analyzer module 304 may analyze the received data frame by frame to determine such one or more parameters, without departing from the scope of the present disclosure.

In an embodiment, the anomaly detector 306 may identify a deviation of content consumption behavior with respect to historical content consumption behaviors of the one or more sub-profiles based at least on the identified one or more parameters. A multi-dimensional vector representing the media recommendation profile 318 of the media account may be used to maintain historical content consumption behavior. Data points from content consumption data may be compared with respect to this multi-dimensional vector to determine the deviation. The deviations may correspond to deviations from the viewing patterns of the user corresponding to the media recommendation profile 318 or the one or more sub-profiles in terms of genre of content, time of content consumption, length of content consumption, rating associated with the media content, associated actors, associated directors, associated scriptwriter, language of media content, plot information associated with media content and other such metadata that can be used by any recommendation engine. Further, the anomaly detector 306 may detect an anomaly in the content consumption behavior of the user if the identified deviation is more than a pre-defined threshold. The pre-defined threshold may be determined based on a calculated standard deviation of the media recommendation profile 318 or any of the sub-profiles, or may be calibrated manually by the one or more users associated with the media account. In one example, if a user typically watches an action movie at dinner time and is currently watching a romantic movie then it may be identified as an anomaly. In another example, if a user typically watches a particular TV series on the weekend and is currently watching a movie instead then it may be identified as an anomaly. In yet another example, if a user listens to focus music on weekdays from 9 A.M. to 6 A.M. but is currently listening to a road trip songs playlist then it may be identified as an anomaly.

In one scenario, if the identified deviation is less than the pre-defined threshold then the deviation may be considered as one of the one or more sub-profiles. For example, if a user typically watches a romantic movie at dinner time and is now watching a romantic comedy (ROM-COM) then it may not be identified as an anomaly as both genres are largely related and may be categorized under a sub-profile of watching a romantic movie at dinner time. In another scenario, if the anomaly occurs for more than a pre-defined time period then only the anomaly will be considered for categorizing as one of the sub-profiles and the restoration point. For example, if a user used to watch an action thriller at dinner time but has started watching a ROM-COM and has been watching it for more than an hour then only it may be categorized as a sub-profile or a restoration point. In yet another scenario, if the anomaly occurs for less than the pre-defined time period then it may be discarded. For example, if a user typically watches an action thriller at dinner time but starts a ROM-COM and ends it within 10 minutes, then it may not be useful data for the system 300 and may be discarded from consideration. In yet another scenario, if the anomaly occurs regularly for more than a pre-defined number of times then the anomaly is considered as a new sub-profile and stored in the database. For example, if a user used to watch an action thriller at dinner time but has started watching a ROM-COM for the past 15 days then only it may be categorized as a new sub-profile for future recommendations. Additionally, if similar anomalies occur for more than a pre-defined number of times, then the anomaly detector 306 may highlight such similar anomalies and after confirmation from any of the primary users consider such anomalies to update the sub-profile or build a new sub-profile.

In an embodiment, the restoration point creator 308 may create a restoration point based on the detection of the anomaly to mark content consumption data collected after or between different restoration points to be discarded from the media recommendation profile 318. Further, the created restoration points may be stored with the added identified one or more parameters as restoration points data 316 (also called RP Data 316) in the database 106. The restoration point creator 308 may further facilitate the user to select the restoration point. The restoration point may be presented over a timeline graph along with a time reference to the user. Further, the restoration points may be presented along with an associated tag, indicative of a past time to facilitate the primary users to restore the instant of the media recommendation profile 318 or sub-profiles that the recommendation engine should use to provide a content recommendation. The restoration point creator 308 may allow the user of the media account to mark content consumption data collected after or between different restoration points to be discarded from the media recommendation profile 318. In an embodiment, the profile updation module 310 may update the media recommendation profile 318 by removing the content consumption data collected after the restoration point to improve the accuracy of personalized recommendation so as to prevent content recommendation based on content consumption data collected after or between different restoration points. Accordingly, based on the selection of the restoration point, the profile updation module 310 may help restore the instance of the media recommendation profile 318 before the detected anomaly in the content consumption behavior of the media account by removing the content consumption data collection after the restoration point to improve the accuracy of personalized recommendation.

In an embodiment, the sub-profile creator 312 may form the one or more sub-profiles based on the identified one or more parameters associated with the media contents played on the one or more media devices. In order to form the one or more sub-profiles, the sub-profile creator 312 may form clusters of genres that are typically watched together based on the analysis of the media content played on the media device 102. For example, one or more users associated with the media account may generally watch a first collection of genres (such as action, thriller, horror, and documentaries) together and a second collection of genres (such as romantic, comedy, animation, and period dramas) together. Such first and second collections of genres may represent the viewing patterns of the user and may be stored as sub-profiles i.e. a sub-profile 1 and a sub-profile 2. Additionally, the sub-profile creator 312 may assign a time of day to the formed one or more sub-profiles for forming the complete viewing pattern of the user. For example, if the user watched the contents related to sub-profile 1 during dinner time and watched the contents related to sub-profile 2 over a weekend, then the sub-profile creator module may assign corresponding associated time to the sub-profiles for forming the complete viewing pattern of the user i.e. what a user typically watches during dinner time and over the weekend. In an embodiment, sub-profile data 314 (also called SP Data 314) pertaining to the formed one or more sub-profiles may be stored in the database 106 for detecting anomalies and/or providing recommendations to the user.

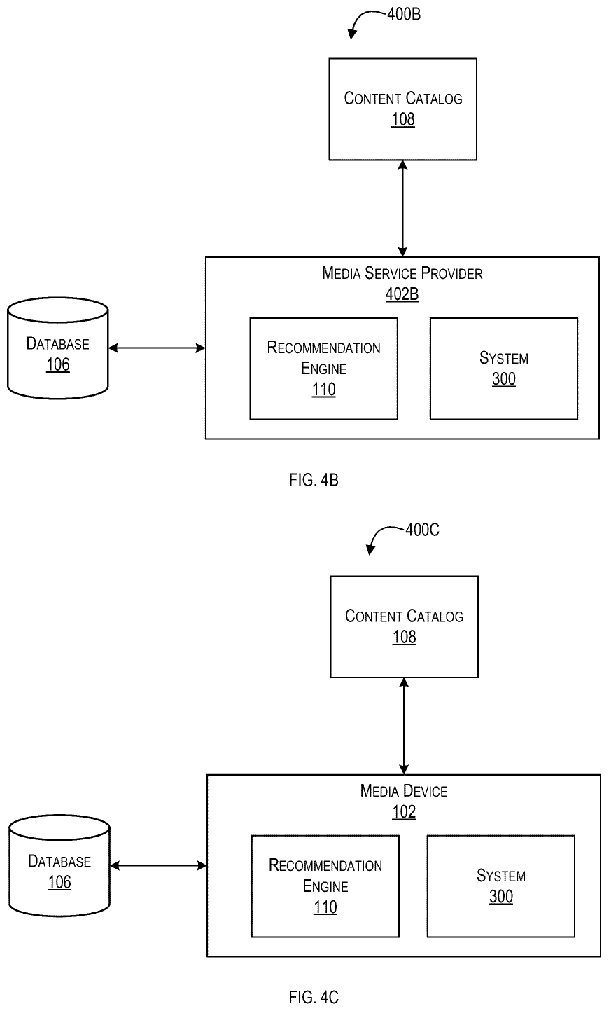

FIG. 4A illustrates an example implementation 400A of the proposed system 300, by a media service provider 402A that uses a third-party recommendation engine 110, in accordance with an embodiment of the present disclosure. FIG. 4B illustrates another exemplary implementation 400B of the proposed system 300, with a media service provider 402B that has an inbuilt recommendation engine 110, in accordance with an embodiment of the present disclosure. FIG. 4C illustrates another exemplary implementation 400C of the proposed system 300, on a media device 102 having its own recommendation engine 110, in accordance with an embodiment of the present disclosure. For the sake of brevity, FIGS. 4A, 4B, and 4C have been explained together.

In an illustrated embodiment, as shown in FIG. 4A, the media service provider 402A, such as OTT or a linear content provider, may utilize a third-party recommendation engine 110 for generating one or more media content recommendations from the content catalog 108 of the media service provider 402A through the restoration points data 316 and/or the sub-profile data 314 stored in the database 106 of the media service provider 402A. In another illustrated embodiment, as shown in FIG. 4B, the media service provider 402B, such as OTT or a linear content provider, may have an in-built recommendation engine 110 for generating one or more media content recommendations from the content catalog 108 of the media service provider 402B through the restoration points data 316 and/or the sub-profile data 314 stored in the database 106 of the media service provider 402B. In yet another illustrated embodiment, as shown in FIG. 4C, the media device 102, such as the television or a mobile phone, may have an in-built recommendation engine 110 for generating one or more media content recommendations from the content catalog 108 of the media device 102 and/or a third-party content provider through the restoration points data 316 and/or the sub-profile data 314 stored in the database 106 of the media device 102.

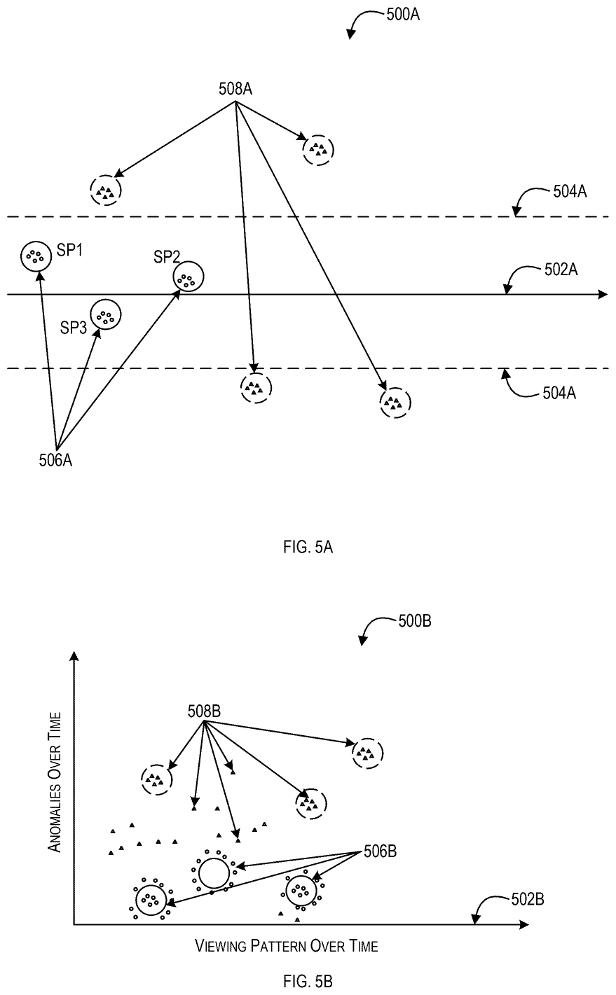

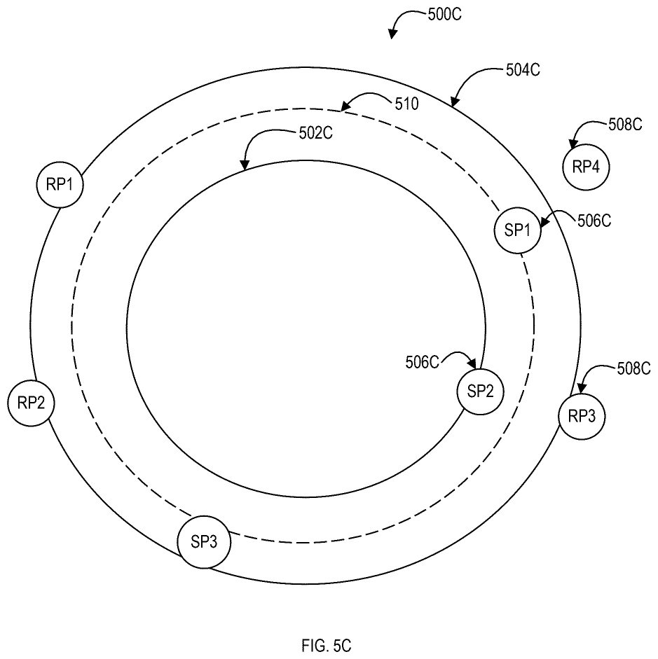

FIG. 5A illustrates an exemplary illustration 500A of anomaly clusters in comparison to a standard content consumption behavior 502A of the media account, in accordance with an embodiment of the present disclosure. FIG. 5B illustrates another exemplary illustration 500B of the anomaly clusters in comparison to the content consumption behavior 502B of the media account, in accordance with an embodiment of the present disclosure. FIG. 5C illustrates yet another exemplary illustration 500C of the anomaly clusters in comparison to the content consumption behavior 502C of the media account, in accordance with an embodiment of the present disclosure. For the sake of brevity, FIGS. 5A, 5B, and 5C have been explained together.

In an illustrated embodiment, as shown in FIG. 5A, one or more anomalies may be identified in the media viewing history of the user. In order to categorize such one or more anomalies, the system 300 may first form a threshold 504A for the standard content consumption behavior 502A of the user over time. Then, the system 300 may form clusters of anomalies that are in proximity of one another for accurate categorization of the anomalies. Thereafter, the system 300 may identify one or more anomaly clusters 506A that are within the threshold 504A of the standard content consumption behavior 502A of the user and consider them as one or more sub-profiles of the user. Further, the system 300 may identify one or more anomaly clusters 508A that are away from the threshold 504A of the standard content consumption behavior 502A of the user and consider them for creating one or more recommendation restoration points for the user, such that the user may restore recommendation prior to such anomalies for receiving continuous and accurate media recommendations in future.

In an illustrated embodiment, as shown in FIG. 5B, a graph may be shown with an x-axis representing the content consumption behavior 502B of the user over time and a y-axis representing anomalies over time. When one or more anomalies are identified in the media viewing history of the user, then the system 300 may form clusters of such anomalies that are in proximity of one another through one or more anomaly detection techniques such as density-based space clustering, Gaussian mixture models and/or K-means. In case, when the clusters are in close proximity to the origin of the graph, then such one or more anomaly clusters 506B may be considered for sub-profiles. In case, when the clusters are away from the origin of the graph, then such one or more anomaly clusters 508B may be considered restoration points.

In an illustrated embodiment, as shown in FIG. 5C, one or more anomalies may be identified in the media viewing history of the user. In order to categorize such one or more anomalies, the system 300 may first form a threshold 504C along with a relevance of the user's viewing pattern 510 for the content consumption behavior 502C of the user over time. Then, the system 300 may form clusters of anomalies that are in proximity of one another for accurate categorization of the anomalies. Thereafter, the system 300 may identify one or more anomaly clusters 506C that are within the content consumption behavior 502C of the user over time and the relevance of the user's viewing pattern 510 and consider them as one or more sub-profiles of the user. Further, the system 300 may identify one or more anomaly clusters 508C that may lie between the threshold 504A and the relevance of the user's viewing pattern 510 or outside the relevance of the user's viewing pattern 510 to consider them for creating one or more recommendation restoration points for the user, such that the user may restore recommendation prior to such anomalies for receiving continuous and accurate media recommendations in future.

In an embodiment of the present invention, the threshold may correspond to a limit where the user's viewing pattern relevance is diminished and may be calculated based on the checking of each anomaly for relevance with the user's main viewing pattern. Thus, if the anomaly is relevant to the user's viewing pattern, it will be considered a subprofile. For example, if a user's main viewing pattern consists of actions, sci-fi, and sports content and the viewing pattern has anomaly detected on a regular basis, such as 4:00 pm-5:00 pm: a thriller series (like actions with plot twists) and 5:00 pm -7:00 pm: animated actions series (like actions). Then, since such anomalies are relevant, they may be considered as sub-profiles. However, if an anomaly is not relevant to the user's viewing pattern, then it may be considered as a recommendation restoration point. For example, if the detected anomaly is 1:00 pm-3:00 pm—romantic comedy, then such an event may be identified as an anomaly and may be stored along with the restoration point. In an embodiment, the deviation from the relevance may be checked for each anomaly. Additionally, or alternatively, a common/mean of such deviations may be calculated and considered as a threshold to detect and create restoration points. Some of the parameters that may be considered for such categorization may, without any limitation, include genre (such as thriller, action, comedy, or the like), actor preference, routine parameters (such as day routine, weekly routine, special events (such as Christmas, super ball, summer vacations, documentary, or the like).

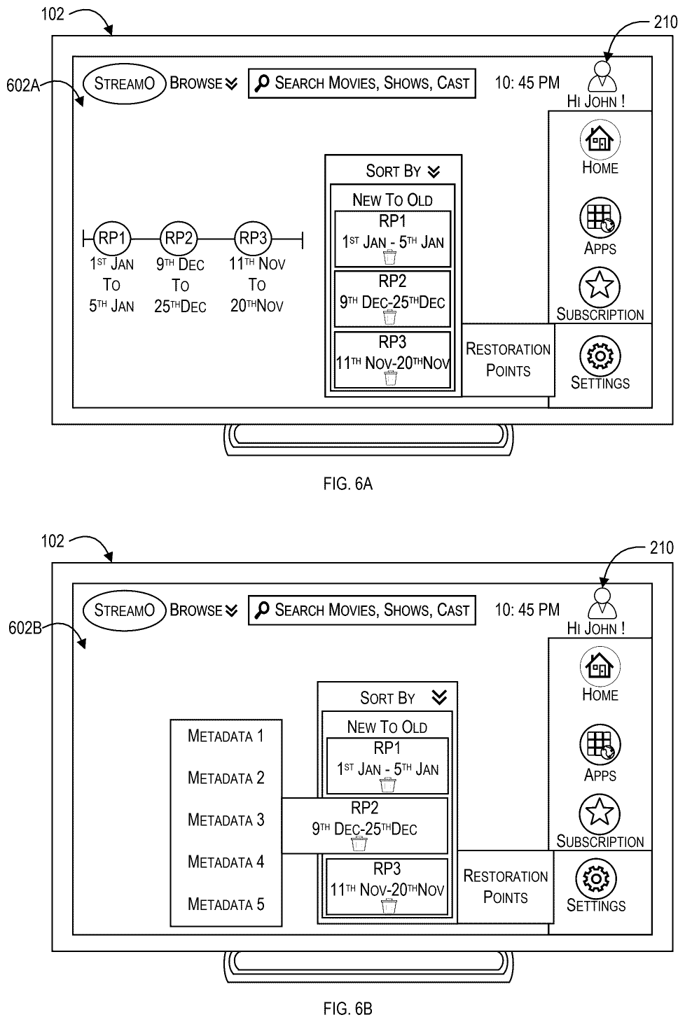

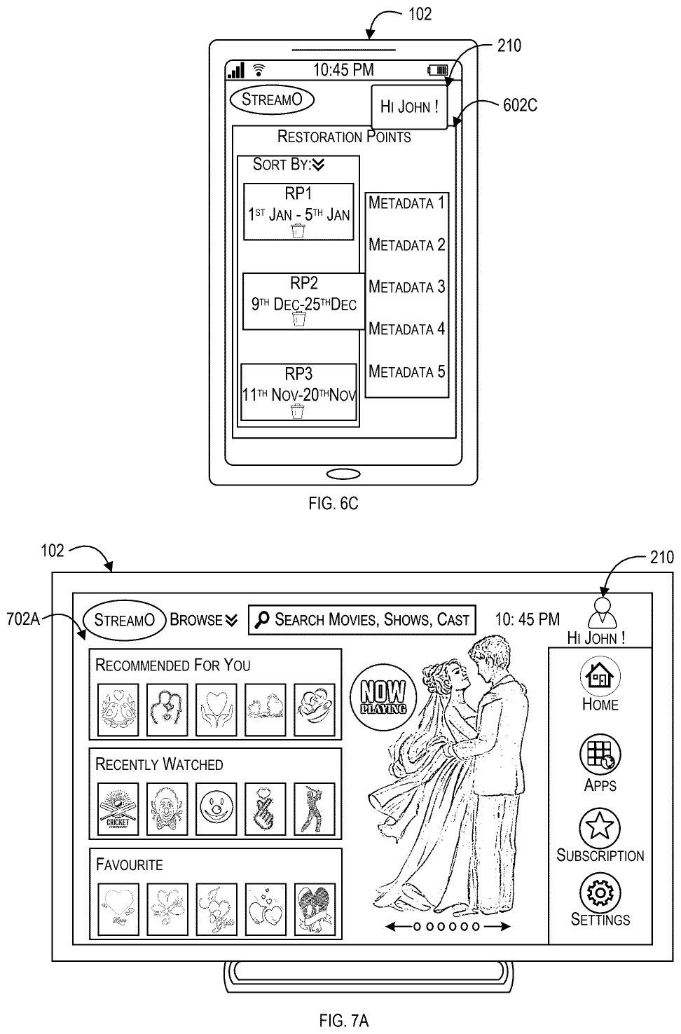

FIG. 6A illustrates an exemplary media recommendation profile setting page 602A with options of various restoration points created for different time ranges, in accordance with an embodiment of the present disclosure. FIG. 6B illustrates an exemplary media recommendation profile setting page 602B showing a highlighted restoration point of potential selection, in accordance with an embodiment of the present disclosure. FIG. 6C illustrates a media recommendation profile setting page 602C showing a highlighted restoration point on a mobile screen, in accordance with an embodiment of the present disclosure. For the sake of brevity, FIG. 6A, 6B, and 6C have been explained together.

In an embodiment, the system 300 may access the database 106 to fetch the restoration points data 316 to render the one or more recommendation restoration points (such as RP1, RP2, and RP3) to the user, as shown in the media recommendation profile setting page 602A. As illustrated, the user may have interactive options, such as sort, delete, or select rendered recommendation restoration points. Such sorting option may facilitate the user to sort the rendered restoration points in terms of, without any limitation, new-to-old, old-to-new, maximum content, maximum relevancy, or the like. The restoration points may be rendered with a corresponding period representing content consumed during that period. For example, RP1 is rendered with a period from 1^{st} Jan-5^{th} Jan, RP2 is rendered with a period from 9^{th} Dec-25^{th} Dec, and RP3 is rendered with a period from 11^{th} Nov-20^{th} Nov. Further, the user may select restoration point to view metadata associated with such restoration point, as shown in the media recommendation profile setting page 602B of FIG. 6B. As illustrated, when the user selects the restoration point RP2, then the metadata (such as metadata 1, metadata 2, metadata 3, metadata 4, and metadata 5) associated with the RP2 may be displayed to the user. Such display of associated metadata may facilitate the user with added information for selecting an action such as deleting or restoring a recommendation from the recommendation restoration point. In an additional embodiment, as shown in FIG. 6C, the media recommendation profile setting page 602C showing the highlighted restoration point on the mobile device 102 may be displayed. As illustrated, since the mobile device 102 is logged in with the same media account as then of the media device 102, as shown in FIG. 6B, the mobile device 102 may illustrate the same one or more recommendation restoration points as well. However, it may be apparent to a person skilled in the art that the system 300 may facilitate the user to decide control of the one or more media devices associated with the media account, such that the user may block the mobile device 102 from deleting the restoration point or may give equal powers to all the logged-in media devices 102.

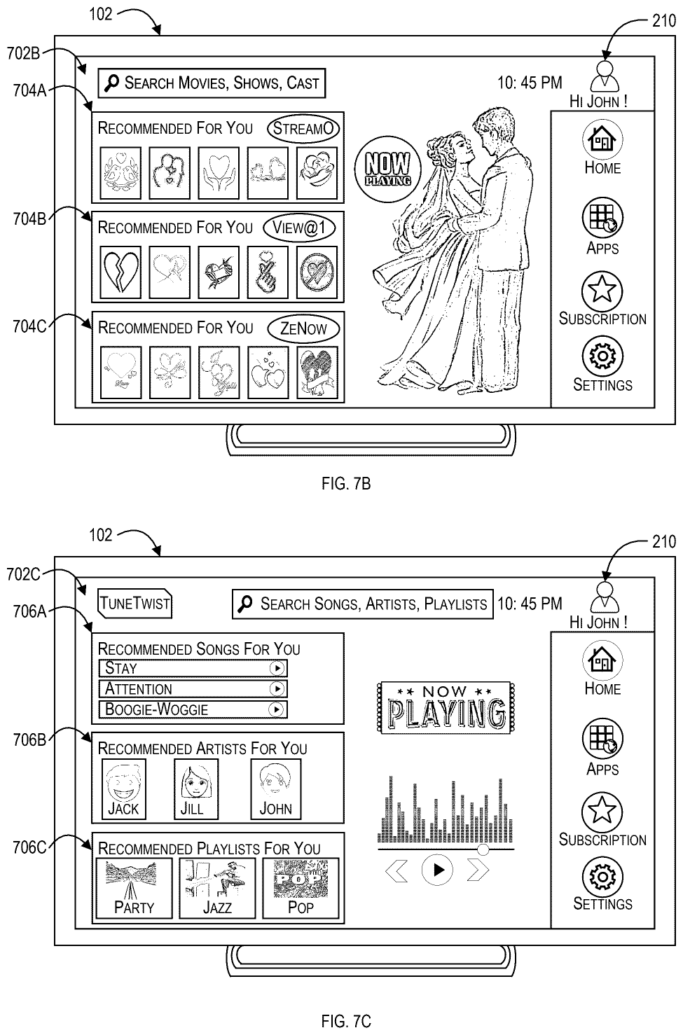

FIG. 7A illustrates an exemplary recommendation screen 702A showing content recommendations based on restored media recommendation profile, in accordance with an embodiment of the present disclosure. FIG. 7B illustrates an exemplary recommendation screen 702B showing recommendations from various streaming platforms based on the restored media recommendation profile, in accordance with an embodiment of the present disclosure. FIG. 7C illustrates an exemplary recommendation screen 702C showing recommendations from a music streaming platform based on a restored media recommendation profile, in accordance with an embodiment of the present disclosure. For the sake of brevity, FIG. 7A, 7B, and 7C have been explained together.

In an embodiment, if the anomalies are not removed from the media recommendation profile of the user, then the one or more recommendations rendered to the user may in addition be based on the anomalies also. For example, as shown in the recommendation screen 202 of FIG. 2, a user typically may watch romantic movies and has a content consumption behavior pertaining to watching romantic movies. Further, guests may visit the user and may watch an action movie from the media account of the user, thus, the one or more recommendations that may be rendered to the user may include one or more action movies along with the romantic movies, as shown in ‘recommendation for you’ 204. However, such issues of irrelevant recommendations may be handled by the system 300, as explained through the FIGS. 7A, 7B, and 7C.

In one embodiment, as shown in the recommendation screen 702A of FIG. 7A, various recommendations may be provided to the user from a media service provider (for example, StreamO) based on the recommendation restoration points. Such restoration points may have the content related to the anomalies removed from them, such that the irrelevant recommendations may not be rendered to the user. As illustrated, such recommendations may be based on the previously watched media (under ‘recommended for you’), recently watched under media, and favorite media selected by the user. It may be understood that such recommendations may be associated with media content stored in the content catalog 108 of the associated content provider (i.e., StreamO in this example). For example, if the user typically watches romantic movies and a guest watches an action movie through the user's media account, then the system 300 may store such instances as an anomaly and create a restoration point that may exclude such anomalies. Based on the user's selection of the created restoration point, the system 300 may render the one or more recommendations excluding such irrelevant recommendations due to the action movie, and may render the recommendations based only on the romantic movies.

In another embodiment, as shown in the recommendation screen 702B of FIG. 7B, various recommendations may be provided to the user from one or more content providers based on the recommendation restoration points. As illustrated, one or more media recommendations may be provided to the user from a first media service provider (i.e., StreamO) 704A, a second media service provider (i.e., View@1) 704B, and a third media service provider (i.e., ZeNow) 704C. In one scenario, the media device 102 may have an in-built recommendation engine 110 for accessing the content catalog 108 of each of the associated media service providers i.e., the first media service provider, the media service content provider, and the third media service provider to provide media recommendations from each of the media service providers. In another scenario, the media device 102 may utilize the respective recommendation engine 110 of the media service provider for providing media recommendations from the media service provider. Accordingly, the selection and deletion of a recommendation restoration point in the media device 102 may affect media recommendations from the different media service providers differently. For example, the effect of selection and deletion of the recommendation restoration point in the media device 102 may have different effects on the first media service provider, the second media service provider, and the third media service provider. The basis for such different effects may, without any limitation, be different respective content catalogs 108, different recommendation algorithms, different user preferences, or the like.

In an embodiment, as shown in the recommendation screen 702C of FIG. 7C, the system 300 may also be implemented in media service providers pertaining to media types other than videos, such as audio, gaming, educational content, or the like. For the purpose of the illustration, media recommendations from a music streaming platform are shown in recommendation screen 702C, but it may be apparent to a person skilled in the art that recommendations pertaining to games and/or educational content may also be provided by utilizing the same technology. In an illustrated embodiment, the recommendations may be provided through a music recommendation platform (such as tunetwist) and may include recommendations of songs 706A (such as, stay, attention, and boogie-woggie), recommendations of artists 706B (such as Jack, Jill, and John), and/or recommendations of playlists 706C (such as party, jazz, and pop).

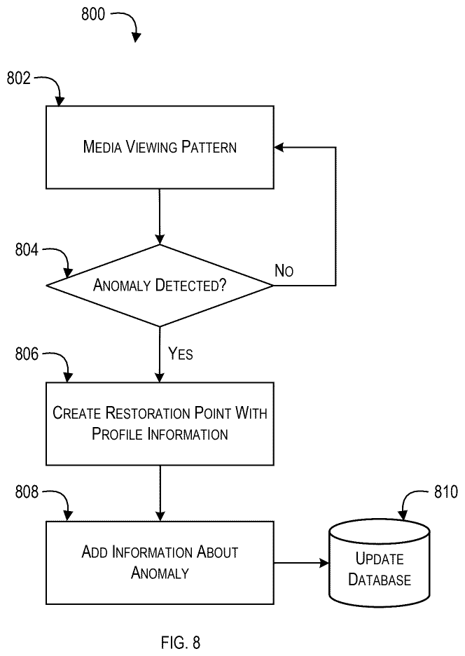

FIG. 8 is a flowchart 800 of an operation for creating media recommendation profile restoration points in the media account, in accordance with an embodiment of the present disclosure. In operation, the system 300 may first receive content consumption data pertaining to media content played on one or more media devices associated with the media account to analyze the viewing pattern of the user, as shown by the block 802. Based on the analyzed viewing pattern, the system 300 may check if there is an anomaly in the viewing pattern of the user, as shown by the block 804. If an anomaly is detected, then the system 300 may create a recommendation restoration point with the profile information, as shown by the block 806. It may be apparent to a person skilled in the art that if the system 300 does not detect anomalies, then the system 300 may continue monitoring the received data pertaining to the media contents being played on the one or more media devices associated with the media account. Further, upon creation of the recommendation restoration points, the system 300 may add information about the detected anomaly such as new genre and/or the time, as shown by the block 808, to update the database 106 with the restoration point data 316 pertaining to the created restoration point, as shown by the block 810.

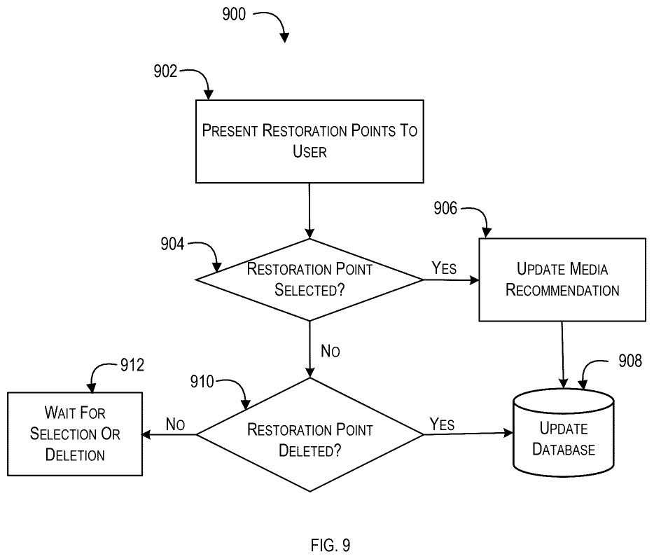

FIG. 9 is a flowchart 900 of an operation of user interaction with the presented restoration points, in accordance with an embodiment of the present disclosure. In operation, the system 300 may render one or more recommendation restoration points to the user, as shown by the block 902. The user may be facilitated with an option to select one of the one or more recommendation restoration points, as shown by the block 904. In one scenario, if the user selects one of the one or more recommendation restoration points, then the system 100 may update the one or more media recommendations to be rendered to the user based on the selected recommendation restoration point, as shown by the block 906. Additionally, the system 100 may also update the restoration points data 316 in the database 106 based on such updation, such as deletion of the restoration point, as shown by the block 908. In another scenario, if the user does not select one of the one or more recommendation restoration points, then the system 100 may check if the user chooses to delete/discard a recommendation restoration point, as shown by the block 910. In one case, if the user deletes the recommendation restoration point, then the system 100 may delete the recommendation restoration point from the restoration points data 316 in the database 106, such that future media recommendations may not consider the contents of such recommendation restoration point. In another case, if the user does not delete the recommendation restoration point, then the system 100 may not perform any activity and waits for the user to perform any action, such as selection or deletion, over one of the one or more rendered recommendation restoration points, as shown by the block 912.

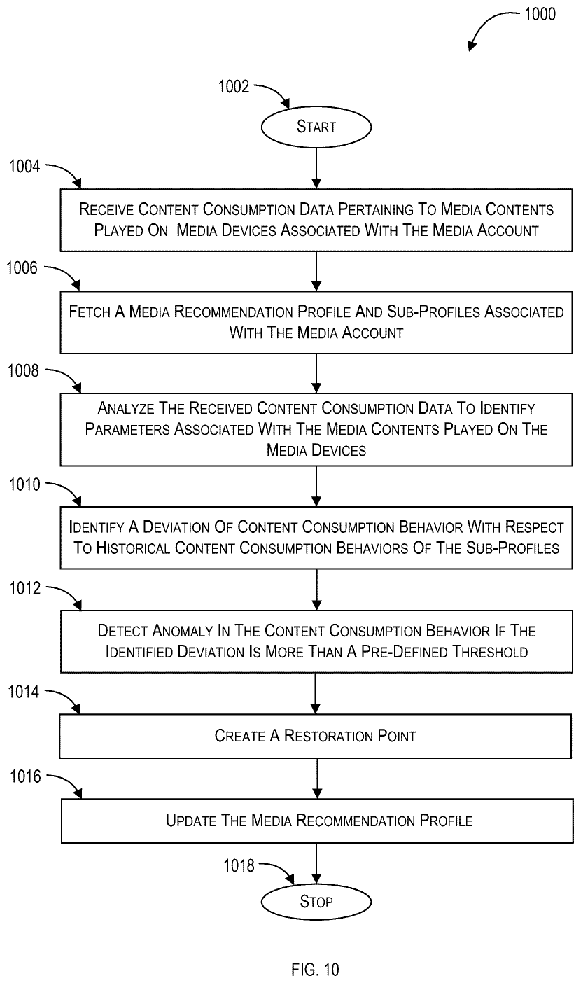

FIG. 10 is a flow chart 1000 of a method for creating recommendation restoration points in the media account, in accordance with an embodiment of the present disclosure. The method starts at step 1002.

At first, content consumption data pertaining to media contents played on one or more media devices associated with the media account may be received, at step 1004. The one or more media devices may be associated with the media account. Further, the media account corresponds to a unique profile, associated with a user or a user device, maintained by an Over The Top (OTT) provider, a linear content provider, a media aggregator, or a content recommendation system.

Next, a media recommendation profile and one or more sub-profiles associated with the media account may be fetched, at step 1006. Each of the one or more sub-profiles corresponds to a viewing pattern of a user associated with the media account. In an embodiment, the one or more sub-profiles may be formed based on the identified one or more parameters associated with the media contents played on the one or more media devices.

Next, the received content consumption data may be analyzed to identify one or more parameters associated with the media contents played on the one or more media devices, at step 1008. The one or more parameters may, without any limitation, include a genre of content, time of content consumption, length of content consumption, rating associated with media content, associated actors, associated directors, associated scriptwriter, language of media content, and plot information associated with media content.

Next, a deviation of content consumption behavior with respect to historical content consumption behaviors of the one or more sub-profiles, at step 1010. The deviation corresponds to deviation from the viewing patterns of the user corresponding to the media recommendation profile or the one or more sub-profiles in terms of genre of content, time of content consumption, length of content consumption, rating associated with the media content, associated actors, associated directors, associated scriptwriter, language of media content, plot information associated with media content and other such metadata that can be used by any recommendation engine.

Next, an anomaly in the content consumption behavior of a user may be detected if the identified deviation is more than a pre-defined threshold, at step 1212. The pre-defined threshold is determined based on at least one of calculated standard deviation of the media recommendation profile, one of the one or more sub-profiles, and manual calibration by one or more users associated with the media account. In one scenario, if the identified deviation is less than the pre-defined threshold, then the deviation is considered as one of the one or more sub-profiles. In another scenario, if the anomaly occurs for less than a pre-defined time period then the anomaly is discarded. Further, if the anomaly occurs regularly for more than a pre-defined number of times then the anomaly is considered as a new sub-profile and stored in the database.

Next, a restoration point may be created based on the detection of the anomaly to facilitate a user to select restoration point, at step 1014. Further, the identified one or more parameters associated with the media contents being played may be added to the created restoration point for facilitating a recommendation engine to provide one or more media content recommendations to the user. Additionally, the created one or more restorations points may be presented to the user and the user may be facilitated with options, such as delete, restore, and sec details. The restoration point is presented over a timeline graph along with a time reference to the user

Thereafter, the media recommendation profile may be updated, at step 1016, by removing the content consumption data collection after the restoration point to improve the accuracy of personalized recommendation. The method ends at step 1018.

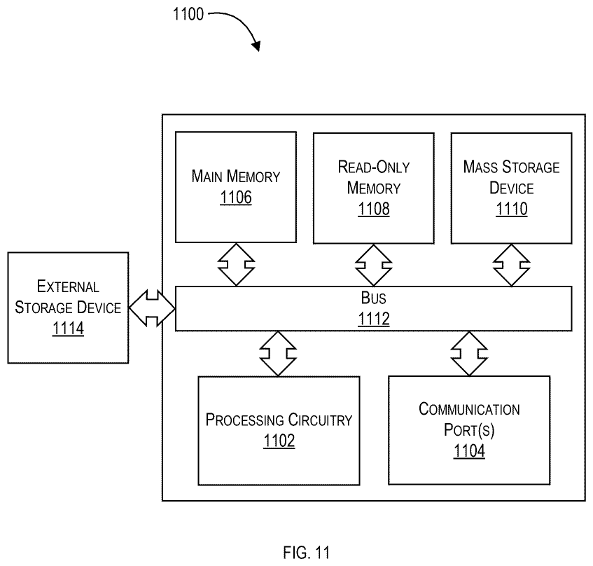

FIG. 11 illustrates an exemplary computer system in which or with which embodiments of the present disclosure may be utilized. As shown in FIG. 11, a computer system 1100 includes an external storage device 1114, a bus 1112, a main memory 1106, a read-only memory 1108, a mass storage device 1110, a communication port 1104, and a processor 1102.

Those skilled in the art will appreciate that computer system 1100 may include more than one processor 1102 and communication ports 1104. Examples of processor 1102 include, but are not limited to, an Intel® Itanium® or Itanium 2 processor(s), or AMD® Opteron® or Athlon MP® processor(s), Motorola® lines of processors, FortiSOC™ system on chip processors or other future processors. The processor 1102 may include various modules associated with embodiments of the present disclosure.

The communication port 1104 can be any of an RS-232 port for use with a modem-based dialup connection, a 10/100 Ethernet port, a Gigabit or 10 Gigabit port using copper or fiber, a serial port, a parallel port, or other existing or future ports. The communication port 1104 may be chosen depending on a network, such as a Local Area Network (LAN), Wide Area Network (WAN), or any network to which the computer system connects.

The memory 1106 can be Random Access Memory (RAM), or any other dynamic storage device commonly known in the art. Read-Only Memory 808 can be any static storage device(s) e.g., but not limited to, a Programmable Read-Only Memory (PROM) chips for storing static information e.g., start-up or BIOS instructions for processor 1102.

The mass storage 1110 may be any current or future mass storage solution, which can be used to store information and/or instructions. Exemplary mass storage solutions include, but are not limited to, Parallel Advanced Technology Attachment (PATA) or Serial Advanced Technology Attachment (SATA) hard disk drives or solid-state drives (internal or external, e.g., having Universal Serial Bus (USB) and/or Firewire interfaces), e.g. those available from Seagate (e.g., the Seagate Barracuda 7200 family) or Hitachi (e.g., the Hitachi Deskstar 7K1000), one or more optical discs, Redundant Array of Independent Disks (RAID) storage, e.g. an array of disks (e.g., SATA arrays), available from various vendors including Dot Hill Systems Corp., LaCie, Nexsan Technologies, Inc. and Enhance Technology, Inc.

The bus 1112 communicatively couples processor(s) 1102 with the other memory, storage, and communication blocks. The bus 1112 can be, e.g., a Peripheral Component Interconnect (PCI)/PCI Extended (PCI-X) bus, Small Computer System Interface (SCSI), USB, or the like, for connecting expansion cards, drives, and other subsystems as well as other buses, such a front side bus (FSB), which connects processor 1102 to a software system.

Optionally, operator and administrative interfaces, e.g., a display, keyboard, and a cursor control device, may also be coupled to bus 1104 to support direct operator interaction with the computer system. Other operator and administrative interfaces can be provided through network connections connected through communication port 1104. An external storage device 1110 can be any kind of external hard-drives, floppy drives, IOMEGA® Zip Drives, Compact Disc-Read-Only Memory (CD-ROM), Compact Disc-Re-Writable (CD-RW), Digital Video Disk-Read Only Memory (DVD-ROM). The components described above are meant only to exemplify various possibilities. In no way should the aforementioned exemplary computer system limit the scope of the present disclosure.

While embodiments of the present disclosure have been illustrated and described, it will be clear that the disclosure is not limited to these embodiments only. Numerous modifications, changes, variations, substitutions, and equivalents will be apparent to those skilled in the art, without departing from the spirit and scope of the disclosure, as described in the claims.

Thus, it will be appreciated by those of ordinary skill in the art that the diagrams, schematics, illustrations, and the like represent conceptual views or processes illustrating systems and methods embodying this disclosure. The functions of the various elements shown in the figures may be provided through the use of dedicated hardware as well as hardware capable of executing associated software. Similarly, any switches shown in the figures are conceptual only. Their function may be carried out through the operation of program logic, through dedicated logic, through the interaction of program control and dedicated logic, or even manually, the particular technique being selectable by the entity implementing this disclosure. Those of ordinary skill in the art further understand that the exemplary hardware, software, processes, methods, and/or operating systems described herein are for illustrative purposes and, thus, arc not intended to be limited to any particular named.

As used herein, and unless the context dictates otherwise, the term “coupled to” is intended to include both direct coupling (in which two elements that are coupled to each other contact each other) and indirect coupling (in which at least one additional clement is located between the two elements). Therefore, the terms “coupled to” and “coupled with” are used synonymously. Within the context of this document terms “coupled to” and “coupled with” are also used euphemistically to mean “communicatively coupled with” over a network, where two or more devices can exchange data with each other over the network, possibly via one or more intermediary device.

It should be apparent to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refer to at least one of something selected from the group consisting of A, B, C . . . and N, the text should be interpreted as requiring only one element from the group, not A plus N, or B plus N, etc.

While the foregoing describes various embodiments of the invention, other and further embodiments of the invention may be devised without departing from the basic scope thereof. The scope of the invention is determined by the claims that follow. The invention is not limited to the described embodiments, versions, or examples, which are included to enable a person having ordinary skill in the art to make and use the invention when combined with information and knowledge available to the person having ordinary skill in the art.

What is claimed is:

1. A system for creating recommendation restoration points in a media account, the system comprises:
a receiver module to:
receive content consumption data pertaining to media contents played on one or more media devices associated with the media account;
fetch a media recommendation profile and one or more sub-profiles associated with the media account;
an analyzer module to analyze the received content consumption data to identify one or more parameters associated with the media contents played on the one or more media devices;
an anomaly detector to:
identify a deviation of content consumption behavior with respect to historical content consumption behaviors of the one or more sub-profiles based at least on the identified one or more parameters;
detect anomaly in the content consumption behavior if the identified deviation is more than a pre-defined threshold;
a restoration point creator to create a restoration point based on the detection of the anomaly to facilitate a user to select the restoration point; and
a profile updation module to update the media recommendation profile by removing the content consumption data collected after the restoration point to improve accuracy of personalized recommendations.

2. The system of claim 1, wherein the restoration point is presented over a timeline graph along with time reference to the user.

3. The system of claim 1, wherein the media account corresponds to a unique profile, associated with a user or a user device, maintained by an Over The Top (OTT) provider, a linear content provider, a media aggregator, or a content recommendation system.

4. The system of claim 1, wherein each of the one or more sub-profiles correspond to a viewing pattern of a user associated with the media account.

5. The system of claim 1, further comprises a sub-profile creator to form the one or more sub-profiles based on the identified one or more parameters associated with the media contents played on the one or more media devices.

6. The system of claim 1, wherein the one or more parameters include a genre of content, time of content consumption, length of content consumption, rating associated with media content, associated actors, associated directors, associated scriptwriter, language of media content, and plot information associated with media content.

7. The system of claim 1, wherein if the identified deviation is less than the pre-defined threshold then the deviation is considered as one of the one or more sub-profiles.

8. The system of claim 1, wherein if the anomaly occurs for less than a pre-defined time period then the anomaly is discarded.

9. The system of claim 1, wherein if the anomaly occurs regularly for more than a pre-defined number of times then the anomaly is considered as a new sub-profile and stored in the database.

10. The system of claim 1, wherein the pre-defined threshold is determined based on at least one of: calculated standard deviation of media recommendation profile, one of the one or more sub-profiles, and manual calibration by one or more users associated with the media account.

11. A method for creating recommendation restoration points in a media account, the method comprises:
receiving content consumption data pertaining to media contents played on one or more media devices associated with the media account;
fetching a media recommendation profile and one or more sub-profiles associated with the media account;
analyzing the received content consumption data to identify one or more parameters associated with the media contents played on the one or more media devices;
identifying a deviation of content consumption behavior with respect to historical content consumption behaviors of the one or more sub-profiles based at least on the identified one or more parameters;
detecting anomaly in the content consumption behavior if the identified deviation is more than a pre-defined threshold;
creating a restoration point based on the detection of the anomaly to facilitate a user to select the restoration point; and
updating the media recommendation profile by removing the content consumption data collected after the restoration point to improve accuracy of personalized recommendation.

12. The method of claim 11, wherein the restoration point is presented over a timeline graph along with time reference to the user.

13. The method of claim 11, wherein the media account corresponds to a unique profile, associated with a user or a user device, maintained by an Over The Top (OTT) provider, a linear content provider, a media aggregator or a content recommendation system.

14. The method of claim 11, wherein each of the one or more sub-profiles correspond to a viewing pattern of a user associated with the media account.

15. The method of claim 11, further comprises forming the one or more sub-profiles based on the identified one or more parameters associated with the media contents played on the one or more media devices.

16. The method of claim 11, wherein the one or more parameters include a genre of content, time of content consumption, length of content consumption, rating associated with media content, associated actors, associated directors, associated scriptwriter, language of media content, and plot information associated with media content.

17. The method of claim 11, wherein if the identified deviation is less than the pre-defined threshold then the deviation is considered as one of the one or more sub-profiles.

18. The method of claim 11, wherein if the anomaly occurs for less than a pre-defined time period then the anomaly is discarded.

19. The method of claim 11, wherein if the anomaly occurs regularly for more than a pre-defined number of times then the anomaly is considered as a new sub-profile and stored in the database.

20. The method of claim 11, wherein the pre-defined threshold is determined based on at least one of: calculated standard deviation of media recommendation profile, one of the one or more sub-profiles, manual calibration by one or more users associated with the media account.
